(19) United States
(12) Patent Application Publication
(10) Pub. No.: US 2008/0241470 A1
(43) Pub. Date: Oct. 2, 2008

(54) Method For Molding a Profiled Weatherstrip on a Glazing

(76) Inventors: Guy Leclercq, Cambronne Les Ribecourt (FR); Thierry Thuillier, Salency (FR); Fabrice Ducreuzot, Ribecourt (FR)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/817,688

(22) PCT Filed: Mar. 3, 2005
(86) PCT No.: PCT/FR05/50144

§ 371 Date: May 9, 2008

(51) Int. Cl. B32B 3/02

(52) U.S. Cl. 428/122; 264/240; 425/206

(57) ABSTRACT

The invention relates to a process for molding a profiled bead (1) made of a plastics material composed of a plurality of components, especially of a polyurethane-based material, onto at least a peripheral part of a glazing unit (2) with the aid of at least one injection head (3), in which process said material ejected through an outlet opening (4) in the injection head (3) then penetrates into a molding cavity (5) to form said molded profiled bead, characterized in that the material ejected through said outlet opening (4) in the injection head (3) penetrates directly into said molding cavity (5).

The present invention relates to a process for molding a profiled bead made of a plastics material composed of a plurality of components, especially of a polyurethane-based material, onto at least a peripheral part of a glazing unit with the aid of at least one injection head, a process in which said material ejected through an outlet opening in the injection head then penetrates into a molding cavity to form said molded profiled bead.

The present invention equally relates to the device for implementing the process, as well as to the glazing unit obtained by the implementation of the process.

The molding of plastics materials composed of a plurality of components has long been known and is used to form, for example according to the technique known as “encapsulation”, polyurethane profiled beads on the peripheral edge of glazing units and especially of motor vehicle glazing units, in particular by the implementation of the technology known as RIM (“Reaction Injection Molding”).

In order for the constituents, in this instance at least the polyol and the isocyanate, to mix together well and for the final material forming the seal to have a homogenous appearance with no point defects in the shape of bubbles, irregularities, . . . the person skilled in the art has always considered that it was necessary for the material to travel through an intermediate means of the distribution channel or mixing cavity and/or homogenizing cavity type, situated between the outlet opening in the injection head and the molding cavity per se, which allows the molded bead to be realized.

The object of this intermediate means was to allow the reactive mixture to flow into the mold in a laminar fashion and without the formation of bubbles.

This mixing and/or homogenizing cavity, situated in front of the molding cavity with regard to the direction of injection of the material, is sometimes referred to as the “injection cone” or “injection blade” or, indeed, as the “injection sprue” or “static mixer”. This cavity is sometimes provided with a constriction portion, that is to say a portion in which its cross section is reduced.

When the injected material is a thermosetting plastic, the whole of the material present in the intermediate means has to be discarded, since it cannot be recycled. Now, the quantity of material present in this intermediate means, in particular when a mixing and homogenizing effect is realized there, can account for up to one third of the total quantity of material injected into the molding cavity for the production of the molded bead.

Moreover, the connecting region between the material situated in the intermediate means and the material forming the molded bead, sometimes referred to as the “injection threshold” of the product, must undergo a finishing step involving the cutting of flashes, then sanding of the cut regions in order to mask the difference in appearance of the part in this region, since the break between the two parts of the material is never smooth and straight. As this step is difficult to automate, its manual realization gives rise to added costs during the production.

As this injection threshold is sometimes positioned, moreover, at the end of a lip of the profiled bead, this step must be carefully executed so as not to damage the lip during the cutting of the flashes, and then during the sanding.

Furthermore, the cavity which allows the mixing and/or homogenization to be realized is generally hollowed out in one of the parts which make up the mold. The presence of this cavity thus complicates the research preceding the realization and production of the mold. The presence of this cavity also gives rise to added costs in the design of the mold.

For the molding of complex shapes, in particular, it is sometimes necessary to realize the mixing and/or homogenizing cavity with mold elements, or “wedges”, which are propelled during the demolding by a translatory and/or rotary motion so as to allow the material contained in the cavity to be released from the intermediate means. Complex configurations of this kind obviously give rise to substantial added costs in the research preceding the realization of the mold, as well as in the production of the mold. These realizations additionally complicate the maintenance of the mold, since their poor functioning can give rise to material losses and thus diminish the quality of the material from which the profiled bead is made.

Numerous works are available to the person skilled in the art to allow him to dimension the necessary intermediate means according to the production parameters.

Furthermore, the person skilled in the art is familiar with an injection channel of a particular type from European patent application no. EP 629 482.

The object of the invention is to alleviate the drawbacks of the prior art by proposing an injection process for multi-component material, which process no longer requires the presence of an intermediate means such as defined above and whose means for the implementation thereof are thus simpler and less onerous to design and use.

The inventors recognized that, surprisingly, it was perfectly possible to realize the injection of the material directly into the molding cavity, without passing the material through an intermediate means.

The present invention also relates in its broader sense to a process for molding a profiled bead made of a plastics material composed of a plurality of components, especially of a polyurethane-based material, onto at least a peripheral part of a glazing unit with the aid of at least one injection head, in which said material ejected through an outlet opening in the injection head then penetrates into a molding cavity to form said molded profiled bead, characterized in that the material ejected through said outlet opening in the injection head penetrates directly into said molding cavity.

This molding cavity is delimited by molding walls between which the injected material spreads, as well as by the glazing unit to which the bead is to adhere.

Thus, the plastics material composed of a plurality of components and ejected through said outlet opening in the injection head does not travel through an intermediate means of the distribution channel or mixing cavity type, situated between said outlet opening and said molding cavity. The distance between the outlet opening in the injection head and the surface of the adjacent glazing unit on which the profiled bead is formed corresponds to the height of the profiled bead at this level on the finished product; no other material is lost.

Within the meaning of the present invention, the term “multi-component plastics material” is intended to convey that the plastics material per se, in order to reticulate, requires the intermixing and interreaction of a plurality of monomers; the chosen term does not therefore cover a plastics material which would need one or more polymerization agent(s) in small or very small proportion (in proportion less than 10%), such as, for example, a catalyst and/or an accelerator.

The material used for the implementation of the invention can comprise, apart from the multi-component plastics material, reinforcing elements, such as, for example, glass fibers. In the case of a plastics material with polyurethane base, these reinforcing elements are added to the polyalcohols in a known manner.

The material is preferably ejected through said outlet opening at the level of a wall of said molding cavity, that is to say that the mean plane of the outlet opening is substantially merged into the mean plane of the wall at this place.

Moreover, the material is preferably ejected through said outlet opening according to a flow substantially perpendicular to the plane of the adjacent glazing unit.

The present invention equally relates to a device for molding a profiled bead made of a plastics material composed of a plurality of components, especially of a polyurethane-based material, onto at least a peripheral part of a glazing unit, said device comprising at least one injection head comprising an outlet opening through which the material is ejected and a molding cavity for forming said molded profiled bead, characterized in that said outlet opening in the injection head emerges directly into said molding cavity.

This device does not therefore comprise an intermediate means of the distribution channel or mixing cavity type, situated between said outlet opening and said molding cavity.

The outlet opening is preferably arranged flush in a wall of said molding cavity. However, the outlet opening according to the invention can equally be arranged so as to project slightly relative to the wall of the molding cavity at this place (of the order of a few millimeters at most; no more than 5 mm), but this will then produce a hollow mark on the final product; the outlet opening according to the invention can equally be arranged slightly set back relative to the wall of the molding cavity at this place (of the order of a few millimeters at most; no more than 5 mm), but this will then produce a projecting mark on the final product.

The outlet opening in the injection head is provided with a movable flap valve, which is open during the injection of material in order to allow the material to spread into the molding cavity and is closed for the rest of the time.

Thus, no repair of the profiled bead is necessary, since the break at the level of the connecting region between the material remaining in the injection head and the material forming the molded bead is clean, owing to the action of the movable flap valve.

Traditionally, the injection head is arranged fixed beside the mold elements, at least one of which is movable to allow the loading and unloading of the glazing unit respectively before and after the molding of the profiled bead, since this injection head is complex owing to the fact that a plurality of components are mixed together therein and that the components are intended to be recirculated between each material injection period; however, for the implementation of the present invention, the inventors recognized that it was perfectly possible to dispose the injection head in a wall of the mold and consequently, if this mold is movable, that it was possible to apply a motion to the injection head during each molding cycle.

Thus, in one variant, the injection head of the device according to the invention is fixedly connected to a movable mold element.

Likewise, in one variant, the outlet opening in the injection head has a substantially circular section having an axis disposed substantially perpendicular to the adjacent receiving plane of the glazing unit. Thus, if the injection is realized adjacent to a main surface of the glazing unit, this axis is perpendicular to this main surface of the glazing unit; if the injection is realized adjacent to the edge of the glazing unit, the axis of the opening is then perpendicular to this edge.

The present invention equally relates to the glazing unit provided on at least a peripheral part with a molded profiled bead made of a plastics material composed of a plurality of components, especially of a polyurethane-based material, the bead being produced by the implementation of the process according to the invention.

The profiled bead of the glazing unit according to the invention does not contain any mark or trace of deflashing, but may contain an injection mark at the place where the ejection of the material was realized.

This injection mark is preferably situated in a place on the profiled bead which will be barely or not at all visible once the glazing unit is fitted.

Advantageously, by virtue of the invention, it is thus no longer necessary to provide an intermediate means in the upstream part of the mold, the part situated between the injection head and the molding cavity per se. The design and production of the mold are thus simplified and less onerous.

Also advantageously, by virtue of the invention, the risks which are run in case of poor definition of the intermediate means or poor realization thereof are eliminated. Indeed, if the intermediate means has not been properly researched and ultimately proves unsatisfactory, then, since it is made in one part with a part of the molding cavity, should a repair become necessary, the mold part has to be withdrawn from the installation and machining recommenced, which is long and costly and demands a complete shutdown of the molding device.

Moreover, the connecting region between the outlet opening in the injection head and the material forming the molded bead is no longer bound to undergo a finishing step, since this region is smooth and straight. Savings are therefore achieved on the cost of this finishing step.

This connecting region is generally provided in a place which ultimately is barely visible on the finished part, since it generally remains noticeable.

A better understanding of the present invention will be gained from reading the following detailed description of non limiting illustrative embodiments, together with the appended figures, in which:

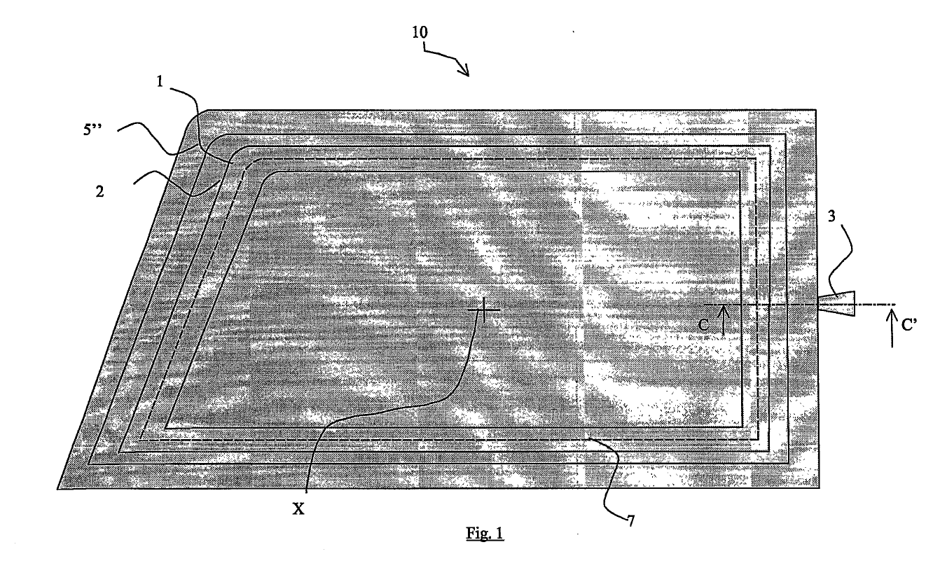

FIG. 1 illustrates a simplified bottom view of a molding device of the prior art onto a horizontally orientated glazing unit, the view being realized level with the bottom surface of the glazing unit;

FIG. 2 illustrates a sectional view along C-C′ of FIG. 1;

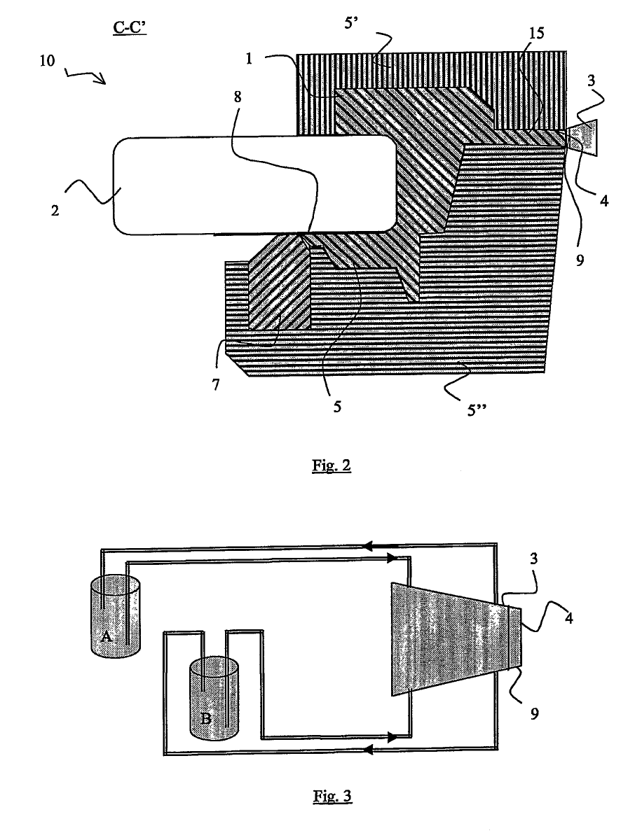

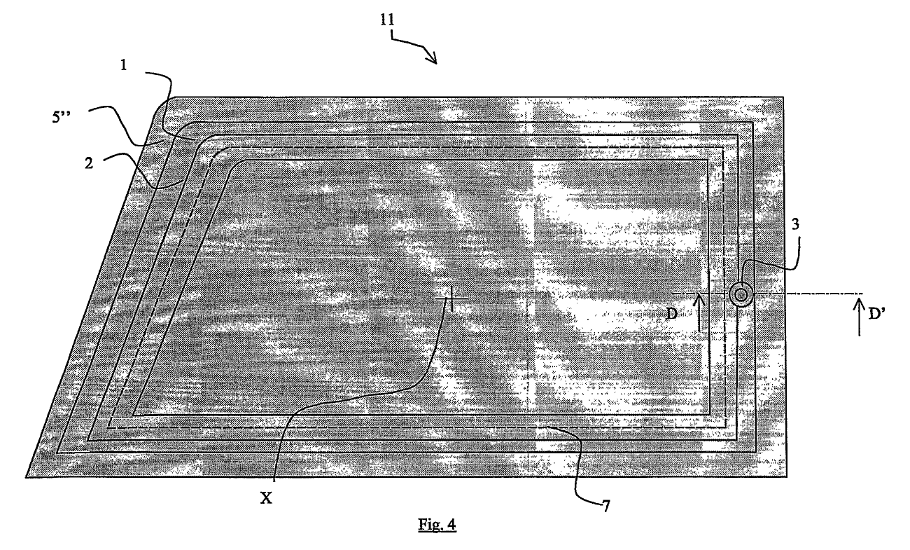

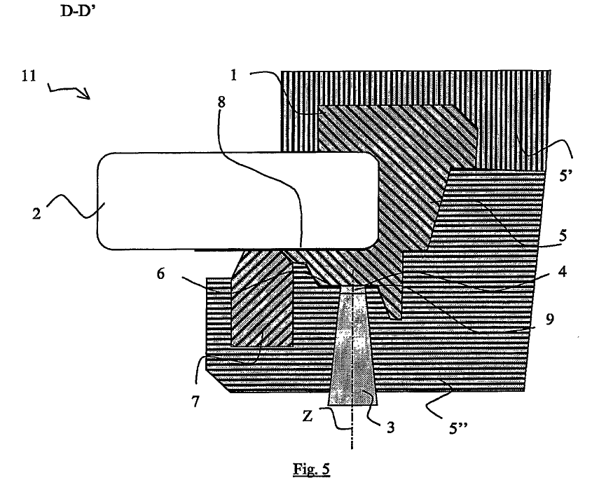

FIG. 3 illustrates the principle of recirculating the two components of the plastics material for supplying the injection head;

FIG. 4 illustrates a simplified top view of a molding device of the invention onto a horizontally orientated glazing unit, the view being realized level with the bottom surface of the glazing unit; and

FIG. 5 illustrates a sectional view along D-D′ of FIG. 4.

It is pointed out that the proportions between the various represented elements are not rigorously observed in these figures so as to make them easier to comprehend.

FIGS. 1 and 2 illustrate a glazing unit (2) on which a profiled bead (1) made of polymer plastics material composed of a plurality of components, here a polyurethane-based material, is realized in a known manner.

The process for producing the bead (1) is referred to as “encapsulation”, since it comprises a step for molding the bead (1) with the aid of a molding device (10) comprising a mold made up of two hollow molding elements defining a molding cavity (5): an upper molding element (5′) and a lower molding element (5″), as can be seen in FIG. 2. Each of these molding elements is generally produced by machining of a metal block.

In general, one molding element, here the lower molding element (5″), is fixed and the other is movable; however, it is equally possible to arrange for both molding elements to be movable.

For the molding, the multi-component plastics material is mixed inside an injection head (3) positioned generally level with a joining plane of the two molding elements (5′, 5″) and is discharged in the direction of the mold through an outlet opening (4).

Before penetrating into the molding cavity (5) to form the molded profiled bead, the material ejected through the injection head (3) travels through a distribution channel (15), which is often cylindrical and is often cut partly in the upper molding element (5′) and partly in the lower molding element (5″).

In FIG. 1, the bead (1) is disposed over the whole of the periphery of the glazing unit (2), but this bead could perfectly well be positioned just on one part of the periphery of the glazing unit or on any part of the glazing unit whatsoever.

For the molding, each molding element is reclosed over the glazing unit (2) by virtue of a weather strip system (7); however, for greater clarity, only the weather strip system (7) of the lower molding element (5″) has been represented.

It is these weather strip systems which allow sufficient pressure to be maintained inside the mold during the injection of the polymer material.

These weather strip systems also, to some extent, allow the production tolerances of the glazing unit to be “corrected”, that is to say allow the variances which might arise with the nominal sizes of the glazing unit in the mold to be compensated for.

Each weather strip system constitutes a ring seal, positioned on the periphery of the glazing unit, and has an axis X, here vertically orientated, since the injection is performed on a horizontally positioned glazing unit; however, the axis X can equally be horizontally orientated, if the injection is performed on a vertically positioned glazing unit, or can be orientated in any other manner.

The weather strip system (7) can be made, for example, of silicone.

It should here be borne in mind that the injection pressure often approaches a few bars to some tens of bars, especially for PU-RIMs.

The glazing unit (2) can be a monolithic glazing unit, that is to say made up of a single sheet of material, or a multiple glazing unit, that is to say made up of a plurality of sheets of material between which there is inserted at least one layer of adhesive material in the case of laminated glazing units, or at least one interspace in the case of double-glazing units. The sheets of material may be mineral, especially of glass, or organic, especially of plastics material.

The glazing unit (2) can thus be a glazing unit for a vehicle, in particular a fixed glazing unit such as a windshield, a side window, a rear quarterlight or, indeed, a roof panel.

In the case of a vehicle glazing unit, the glazing unit generally has, at least on part of its periphery, an ornamental trim (8), as can be seen in FIG. 2. This ornamental trim generally derives from an enamel coating, realized on the inner face of the glazing unit or on an intermediate face of the glazing unit for composite glazing units, but it can equally derive from a partial and/or peripheral coloration of a utilized sheet of material, especially a sheet made from organic material. In the illustrated version, this ornamental trim (8) is realized beneath the glazing unit (2), on the face of the glazing unit intended to be facing toward the interior of the vehicle.

The injection head (3) and the principle of the system for recirculating the material outside of the injection phases are illustrated in detail in FIG. 3.

The injection head (3) is provided at its distal end with a movable flap valve (9), which closes the outlet opening (4) outside of the material injection periods.

Thus, when the flap valve (9) is closed and no plastics material is being injected into the mold, each of the components A and B is sucked up from a reservoir, circulates inside the head and is sent back into its respective reservoir. There is no contact between the components A and B.

It is only during the phase in which the material is injected into the mold that the two return flows toward the respective reservoirs are interrupted, and that the two components A and B find themselves in contact inside the injection head, are mixed and are discharged through the outlet opening (4), the flap valve (9) being open.

In the prior art, the mixing of the constituents of the injected plastics material is performed in the injection head and the full homogenization is often obtained at the downstream end of the distribution channel (15). If the achieved mix is not perfect and the injected material exhibits unacceptable defects, then it is necessary to initiate an iterative process for optimizing the injection parameters in order to alleviate these defects, or even to remake the part of the mold which incorporates the distribution channel (15). This obviously gives rise to a substantial loss of time and, hence, of money.

Furthermore, and above all, the whole of the material which is situated in the distribution channel (15) at the moment of closure of the flap valve (9) at the end of the injection cycle is lost and has to be discarded.

FIGS. 4 and 5 illustrate a glazing unit (2) on which, according to the invention, a profiled bead (1) made of polymer plastics material composed of a plurality of components, here in polyurethane, is realized.

The molding of the bead (1) is performed with the aid of a molding device (11) comprising a mold made up of two hollow molding elements defining a molding cavity (5): an upper molding element (5′) and a lower molding element (5″), as can be seen in FIG. 5.

As can be established, the device according to the invention illustrated in FIGS. 4 and 5 differs from that of the prior art illustrated in FIGS. 1 and 2 in that the material ejected through said outlet opening (4) in the injection head (3) penetrates directly into said molding cavity (5), without, as previously, traveling through an intermediate means of the distribution channel or mixing cavity type, situated between said outlet opening (4) and said molding cavity (5).

The injection head which is used here is the same as previously, but it is no longer positioned as previously: it is henceforth integrated with a molding element, in this case the lower molding element (5″), which is here the fixed molding element, in such a way that the material is ejected through the outlet opening (4) at the level of a wall (6) of the molding cavity (5).

In the version of the invention which is illustrated here, the movable flap valve (9), which closes the outlet opening (4) outside of the material injection periods, lies flush against the wall (6).

There is therefore no longer any material lost in some kind of intermediate means and, for high-volume production runs, the material savings achieved are substantial.

The mixing of the constituents of the injected plastics material is performed in the injection head. If the mix achieved is not perfect and the injected material exhibits unacceptable defects, then it is necessary to initiate an iterative process for optimizing the injection parameters in order to alleviate these defects.

In order to perfect the mixing of the components, it is possible to provide in the injection head, in front of the flap valve (9) with regard to the direction of injection, a constriction portion, that is to say a portion in which the cross section of the components-mixing conduit is reduced.

Surprisingly, moreover, the injection parameters are easily reproducible from one molding to another and when a new part run commences, with a different mold form, if the previously realized injection was correct, even if the quantity of injected material alters, then a small number of trials are sufficient to optimize the new injection and obtain the necessary quality, even though there is no longer any intermediate means for homogenizing the mixture.

The outlet opening (4) has a substantially circular section having an axis Z disposed perpendicular to the adjacent receiving plane of the glazing unit.

Furthermore, in the case of a vehicle glazing unit, the glazing unit generally has, at least on part of its periphery, an ornamental trim (8).

In the version of the invention which is illustrated here, the injection is realized on a face of the bead which is not visible from outside the vehicle once the glazing unit is fitted, in order that the circular mark which might have been made at the level of the flap valve is not visible from outside the vehicle once the glazing unit is fitted.

Moreover, for the same reasons, the injection is realized on a face of the bead which lies behind the ornamental trim (8).

The injection could equally be realized elsewhere: in regions of the glazing unit which will be hidden once the glazing unit is fitted.

Likewise, in the case of a vehicle glazing unit, it is possible to position one (or more) insert(s) in the molding element (5′, 5″) prior to the molding of the bead (1) so that the bead incorporates this (or these) insert(s).

This (or these) insert(s) can be (a) reinforcing insert (s), generally fully integrated with the bead (1), or (a) fastening insert(s), generally protruding beyond the bead, for fastening the glazing unit into the bay intended to receive it.

The glazing unit (2) as can be seen in FIG. 5 is provided with a profiled bead (1) made of a polymer material, having a suitable surface quality which is smooth, with neither irregularities nor bubbles, and contains no flashes, but which does contain an injection mark situated at the place where the injection has been realized. After having left the mold, this glazing unit is then delivered to the customer just as it is. Upon departure from the mold, no deflashing operation is carried out prior to delivery to the customer.

The present invention is described above by way of example. It is appreciated that the person skilled in the art is capable of realizing different variants of the invention without, for all that, departing from the scope of the patent such as defined by the claims.

1. A process for molding a profiled bead (1) made of a plastics material composed of a plurality of components, especially of a polyurethane-based material, onto at least a peripheral part of a glazing unit (2) with the aid of at least one injection head (3), in which process there is recirculation of each of the components inside the injection head outside of the injection phases and mixing of the multi-component plastics material inside the injection head during the injection phase, and in which process said material ejected through an outlet opening (4) in the injection head (3) then penetrates into a molding cavity (5) to form said molded profiled bead, characterized in that the material ejected through said outlet opening (4) in the injection head (3) penetrates directly into said molding cavity (5).

2. The molding process as claimed in claim 1, characterized in that the material ejected through said outlet opening (4) in the injection head (3) does not travel through an intermediate means of the distribution channel or mixing cavity type, situated between said outlet opening (4) and said molding cavity (5).

3. The molding process as claimed in claim 1 or claim 2, characterized in that the material is ejected through said outlet opening (4) in a wall (6) of said molding cavity (5).

4. The molding process as claimed in any one of claims 1 to 3, characterized in that the material is ejected through said outlet opening (4) according to a flow substantially perpendicular to the plane of the adjacent glazing unit.

5. A device (11) for molding a profiled bead (1) made of a plastics material composed of a plurality of components, especially of a polyurethane-based material, onto at least a peripheral part of a glazing unit (2), said device comprising at least one injection head (3), inside which the multi-component plastics material is mixed during the injection phase and which comprises an outlet opening (4) through which said material is ejected, a system for recirculating each of the components inside the injection head outside of the injection phases, and a molding cavity (5) for forming said molded profiled bead, characterized in that said outlet opening (4) in the injection head (3) emerges directly into said molding cavity (5).

6. The device (11) as claimed in the previous claim, characterized in that it does not comprise an intermediate means of the distribution channel or mixing cavity type, situated between said outlet opening (4) and said molding cavity (5).

7. The device (11) as claimed in claim 5 or claim 6, characterized in that said outlet opening (4) is arranged flush in a wall (6) of said molding cavity (5).

8. The device (11) as claimed in any one of claims 5 to 7, characterized in that the injection head (3) is fixedly connected to a movable mold element (5′).

9. The device (11) as claimed in any one of claims 5 to 8, characterized in that said outlet opening (4) has a substantially circular section having an axis Z disposed substantially perpendicular to the adjacent receiving plane of the glazing unit.

10. A glazing unit (2) provided on at least a peripheral part with a molded profiled bead (1) made of a plastics material composed of a plurality of components, especially of a polyurethane-based material, produced by the implementation of the process as claimed in any one of claims 1 to 4.

11. The glazing unit (2) as claimed in the preceding claim, characterized in that the profiled bead (1) does not contain any mark or trace of deflashing.

12. The glazing unit (2) as claimed in claim 10 or 11, characterized in that the profiled bead (1) contains an injection mark at the place where the ejection of the material was realized.

13. The glazing unit (2) as claimed in the preceding claim, characterized in that said injection mark is situated in a place on the profiled bead which will be barely or not at all visible once the glazing unit is fitted.
